(19) United States
(12) Patent Application Publication
(10) Pub. No.: US 2007/0060493 A1
(43) Pub. Date: Mar. 15, 2007

(54) Stabilization of concentrated liquid enzyme additives

(75) Inventor: Hanne Philbert Nielsen, Lyngby (DK)

Correspondence Address: NOVOZYMES NORTH AMERICA, INC., 500 FIFTH AVENUE, SUITE 1600, NEW YORK, NY, 10110, US

(73) Assignee: Novozymes A/S, Bagsvaerd (DK)

(21) Appl. No.: 11/513,920

(22) Filed: Aug. 31, 2006

Related U.S. Application Data
(60) Provisional application No. 60/716,406, filed on Sep. 13, 2005.

(30) Foreign Application Priority Data
Sep. 2, 2005 (DK) PA 2005 01225

(51) Int. Cl. C11D 3/48

(52) U.S. Cl. 510/386

(57) ABSTRACT

The present invention relates to a concentrated liquid enzyme additive comprising enzyme, boronic acid or a derivative thereof and a surfactant, wherein the enzyme is present in the amount of more than 1.5 g/L.

### CROSS REFERENCE TO RELATED APPLICATIONS

This application claims the priority or the benefit of U.S. Provisional application No. 60/716,406, filed Sep. 13, 2005, and Danish application nos. PA 2005 01225, filed Sep. 2, 2005, the contents of which are fully incorporated herein by reference.

### FIELD OF THE INVENTION

The present invention relates to stabilization of a concentrated liquid enzyme additive in order to prevent precipitation. The invention further relates to a process for manufacturing of said liquid enzyme additive.

### BACKGROUND OF THE INVENTION

Storage stability problems are well known in enzyme containing liquids. Especially in enzyme-containing liquid detergents, in particular if the detergent contains protease, it is a major problem to ensure a stabile enzyme activity over time.

The prior art has dealt extensively with improving the storage stability, for example by adding a protease inhibitor.

Boric acid and boronic acids are known to reversibly inhibit proteolytic enzymes. A discussion of the inhibition of one serine protease, subtilisin, by boronic acid is provided in Molecular & Cellular Biochemistry 51, 1983, pp. 5-32.

Boronic acids have very different capacities as subtilisin inhibitors. Boronic acids containing only alkyl groups such as methyl, butyl or 2-cyclohexylethyl are poor inhibitors with methylboronic acid as the poorest inhibitor, whereas boronic acids bearing aromatic groups such as phenyl, 4-methoxyphenyl or 3,5-dichlorophenyl are good inhibitors with 3,5-dichlorophenylboronic acid as a particularly effective one (see Keller et al, Biochem. Biophys. Res. Com. 176, 1991, pp. 401-405).

It is also claimed that aryl boronic acids which have a substitution at the 3-position relative to boron are unexpectedly good reversible protease inhibitors. Especially, acetamidophenyl boronic acid is claimed to be a superior inhibitor of proteolytic enzymes (see WO 92/19707). In EP 0 832 174 it is found that that phenyl boronic acid derivatives substituted in the para-position with a >C═O adjacent to the phenyl boronic acid have extraordinary good capacities as enzyme stabilizers in liquids.

However by solving the stabilization problem of the enzyme, another problem has appeared. When using boronic acid or a boronic acid derivative such as 4-formyl phenyl boronic acid (4-FPBA) in the liquid enzyme additive to stabilize the enzyme it happens that a precipitate is formed during preparation and upon storage which is naturally an unwanted side effect.

### SUMMARY OF THE INVENTION

An object of the present invention is therefore to provide a liquid enzyme additive, comprising an enzyme and a boronic acid or a derivative of boronic acid, which does not form precipitate during preparation or upon storage. A further object of the present invention is to provide a method for manufacturing said liquid enzyme additive with a minimum formation of precipitate.

It has surprisingly been found that adding a surfactant to the liquid enzyme additive decreases the amount of precipitate being formed during storage significantly.

The present invention provides thus in a first aspect of the present invention a concentrated liquid enzyme additive comprising enzyme, a phenyl boronic acid or a derivative thereof and a surfactant, wherein the enzyme is present in the amount of more than 1.5 g/L.

The present invention provides in a second aspect a process for manufacturing a concentrated liquid enzyme additive comprising the following steps:
i) providing a liquid enzyme preparation;
ii) mixing the liquid of i) with a boronic acid or a derivative thereof;
iii) adding a surfactant to the liquid enzyme additive before or after step ii) or together with the boronic acid or derivative thereof.

The present invention further relates to the use of said concentrated liquid enzyme additive.

### DETAILED DESCRIPTION OF THE INVENTION

Defintions

HLB value:

The HLB (hydrophilic-lipophilic balance) value is a kind of index numbered from 1 to 20.

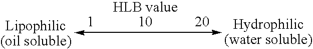

The HLB system is a semi-empirical method to predict what type of surfactant properties a molecular structure will provide. The HLB system is based on the concept that some molecules have hydrophilic groups, other molecules have lipophilic groups, and some have both. Weight percentage of each type of group on a molecule or in a mixture predicts what behavior the molecular structure will exhibit. Water-in-oil emulsifiers have low HLB numbers, typically around 4. Solubilizing agents have high HLB numbers. Oil-in-water emulsifiers have intermediate to high HLB numbers.

HLB is the hydrophile-lipophile balance as described by W. C. Griffin, “Calculation of HLB Values of Non-Ionic Surfactants,” Journal of the Society of Cosmetic Chemists 5 (1954): p 249.

Surfactant:

A chemical that acts as a surface active agent. This term encompasses a multitude of materials that function as emulsifiers, dispersants, oil-wetters, water-wetters, foamers and defoamers. The type of surfactant behavior, whether acting as an emulsifier or dispersant or otherwise, depends on the structural groups on the molecule (or mixture of molecules).

pH:

In the present invention the pH was measured using a pH meter PHM93 from Radiometer and a Ross® semi-micro combination pH electrode (Orion 8103SC). Before being used, the pH electrode was calibrated using standard buffers from Radiometer Analytical (pH 4.005 order no.: S11M002; pH 7.000 order no.: S11M004 and pH 10.012 order no.: S11M007). The pH was measured at room temperature, 23° C.

Enzyme Concentrate:

An enzyme concentrate is an enzyme fermentation broth which have been exposed to removal of liquid and/or removal of unwanted material.

Concentrated Liquid Enzyme Additive:

A concentrated liquid enzyme additive is a product to be used as a raw material or premix in manufacturing of a finished product such as detergents. The concentrated liquid enzyme additive is in the following referred to as the liquid enzyme additive or the concentrated liquid enzyme additive.

Introduction

To use boronic acid and its derivatives as protease stabilizer in liquid detergents has been shown to cause problems. When preparing the liquid enzyme additive comprising said protease stabilizer and upon storage of said liquid enzyme additive, it is seen that a precipitate may be formed. Detergent manufactures require that liquids to be added to their products are clear liquids. The use of unclear liquids may psychologically give the end user an idea of the detergent being contaminated. Therefore it is desirable that liquid detergents are clear and thus the raw materials comprised therein. Furthermore it is easier to pump liquids free of precipitate.

A problem in the manufacture of said liquid enzyme additive is that a precipitate is formed upon storage. We have surprisingly found that addition of a surfactant to the liquid enzyme additive prevent a precipitate of being formed.

Furthermore it is seen during manufacturing of the liquid enzyme additive that a precipitate is being formed. In the pursuit of finding a way of avoiding this precipitate of being formed, it has surprisingly been found that adjustment of pH in the liquid enzyme additive prevent a major part of the precipitate of being formed if the pH is adjusted before addition of the stabilizer and dissolve most of the precipitate if adjusted after the addition of the stabilizer.

The Liquid Enzyme Additive

The liquid enzyme additive of the present invention comprises enzyme, boronic acid or a derivative thereof and a surfactant.

In a particular embodiment of the present invention the liquid enzyme additive has a pH of 5.5 to 10. In a more particular embodiment of the resent invention the pH is 7.5 to 10.

In another particular embodiment of the present invention the liquid enzyme additive further comprises an alkaline substance such as the liquid enzyme additive has a pH of 7.5 to 10 provided by the alkaline substance.

The liquid enzyme additive may comprise additional materials.

In a particular embodiment of the present invention the liquid enzyme additive does not comprise chelants. In a more preferred embodiment of the present invention the liquid enzyme additive does not comprise ethanolamines. In an even more preferred embodiment of the present invention the liquid enzyme additive does not comprise phosphonates. In a most preferred embodiment of the present invention the liquid enzyme additive does not comprise perfume.

Enzymes

The liquid enzyme additive is a concentrated product to be added to liquid detergents. The amount of enzyme used in the liquid enzyme additive is thus very high. In a particular embodiment of the present invention the amount of enzyme present in the liquid enzyme additive is at least 1.5 g/L. In a more particular embodiment of the present invention the amount of enzyme is at least 5 g/L. In an even more particular embodiment of the present invention the amount of enzyme present is at least 10 g/L. In a most particular embodiment of the present invention the amount of enzyme present is at least 20 g/L such as even above 25 g/L. In a particular embodiment the amount of enzyme does not exceed 200 g/L. In a more particular embodiment of the present invention the amount of enzyme does not exceed 150 g/L. In a most particular embodiment of the present invention the amount of enzyme present in the liquid enzyme additive is less than 100 g/L.

In a particular embodiment of the present invention the liquid enzyme additive comprises above 4% by weight of enzyme protein. In a more particular embodiment of the present invention the liquid enzyme additive comprises at least 5% by weight of enzyme protein. In a most particular embodiment of the present invention the liquid enzyme additive comprises at least 7.5% by weight of enzyme protein.

The enzyme is typically produced by fermentation of a bacterium or fungus, and subsequently recovered by methods known within the art. A typical recovery process may consist of the following steps: removal of cells and other solids by centrifugation or filtration and concentration by ultra-filtration and/or evaporation at reduced pressure. A polyol, such as 1,2-propanediol, sorbitol, a simple carbohydrate or glycerol, may be added either immediately before, during or shortly after the concentration step to stabilize the enzyme. A combination of polyols may also be used. Further steps may be included in the recovery process, depending on the specifications of the final product. In order to increase the stability during the processes, e.g. reduce proteolysis including autoproteolysis, the processes are typically run at a pH where the enzyme is stable and their activity is low, e.g. at pH 4.0-6.5. Another way to increase the stability, including reduction of proteolysis, is to run the processes at low temperatures, e.g. below 10° C. However, sometimes it may be advantageous to run e.g. a filtration at a higher temperature in order to increase the flux through the membrane.

According to the invention the liquid composition contains at least one enzyme. The enzyme may be any commercially available enzyme, in particular an enzyme selected from the group consisting of proteases, amylases, lipases, cellulases, lyases, oxidoreductases and any mixture thereof. Mixtures of enzymes from the same class (e.g. proteases) are also included.

According to the invention a liquid composition comprising a protease is preferred. In a particular embodiment a liquid composition comprising two or more enzymes in which the first enzyme is a protease and the second enzyme is selected from the group consisting of amylases, lipases, cellulases, lyases and oxidoreductases is preferred. In a more particular embodiment the second enzyme is a lipase. It is to be understood that enzyme variants (produced, for example, by recombinant techniques) are included within the meaning of the term “enzyme”. Examples of such enzyme variants are disclosed, e.g. in EP 251,446 (Genencor), WO 91/00345 (Novo Nordisk), EP 525,610 (Solvay) and WO 94/02618 (Gist-Brocades NV).

Enzymes can be classified on the basis of the handbook Enzyme Nomenclature from NCIUBMB, 1992), see also the ENZYME site at the internet: http://www.expasy.ch/enzyme/. ENZYME is a repository of information relative to the nomenclature of enzymes. It is primarily based on the recommendations of the Nomenclature Committee of the International Union of Biochemistry and Molecular Biology (IUB-MB), Academic Press, Inc., 1992, and it describes each type of characterized enzyme for which an EC (Enzyme Commission) number has been provided (Bairoch A. The ENZYME database, 2000, Nucleic Acids Res 28:304-305). This IUBMB Enzyme nomenclature is based on their substrate specificity and occasionally on their molecular mechanism; such a classification does not reflect the structural features of these enzymes.

Another classification of certain glycoside hydrolase enzymes, such as endoglucanase, xylanase, galactanase, mannanase, dextranase and alpha-galactosidase, in families based on amino acid sequence similarities has been proposed a few years ago. They currently fall into 90 different families: See the CAZy(ModO) internet site (Coutinho, P. M. & Henrissat, B. (1999) Carbohydrate-Active Enzymes server at URL: http://afmb.cnrs-mrs.fr/˜cazy/CAZY/index.html (corresponding papers: Coutinho, P. M. & Henrissat, B. (1999) Carbohydrate-active enzymes: an integrated database approach. In “Recent Advances in Carbohydrate Bioengineering”, H. J. Gilbert, G. Davies, B. Henrissat and B. Svensson eds., The Royal Society of Chemistry, Cambridge, pp. 3-12; Coutinho, P. M. & Henrissat, B. (1999) The modular structure of cellulases and other carbohydrate-active enzymes: an integrated database approach. In “Genetics, Biochemistry and Ecology of Cellulose Degradation”., K. Ohmiya, K. Hayashi, K. Sakka, Y. Kobayashi, S. Karita and T. Kimura eds., Uni Publishers Co., Tokyo, pp. 15-23).

The liquid enzyme additive preferably comprise a protease, such as a serine protease.

Proteases: Suitable proteases include those of animal, vegetable or microbial origin. Microbial origin is preferred. Chemically or genetically modified mutants are included. The protease may be a serine protease, preferably an alkaline microbial protease or a trypsin-like protease. Examples of al-kaline proteases are subtilisins, especially those derived from Bacillus, e.g., subtilisin Novo, subtilisin Carlsberg, subtilisin 309, subtilisin 147 and subtilisin 168 (described in WO 89/06279). Examples of trypsin-like proteases are tryp-sin (e.g. of porcine or bovine origin) and the Fusarium pro-tease described in WO 89/06270. In a particular embodiment of the present invention the protease is a serine protease. Serine proteases or serine endopeptidases (newer name) are a class of peptidases which are characterised by the presence of a serine residue in the active center of the enzyme.

Serine proteases: A serine protease is an enzyme which catalyzes the hydrolysis of peptide bonds, and in which there is an essential serine residue at the active site (White, Handler and Smith, 1973 “Principles of Biochemistry,” Fifth Edition, McGraw-Hill Book Company, NY, pp. 271-272).

The bacterial serine proteases have molecular weights in the 20,000 to 45,000 Daltons range. They are inhibited by diisopropylfluorophosphate. They hydrolyze simple terminal esters and are similar in activity to eukaryotic chymotrypsin, also a serine protease. A more narrow term, alkaline protease, covering a sub group, reflects the high pH optimum of some of the serine proteases, from pH 9.0 to 11.0 (for review, see Priest (1977) Bacteriological Rev. 41 711-753). Subtilases: A sub-group of the serine proteases tentatively designated subtilases has been proposed by Siezen et al. (1991), Protein Eng., 4 719-737. They are defined by homology analysis of more than 40 amino acid sequences of serine proteases previously referred to as subtilisin-like proteases. A subtilisin was previously defined as a serine protease produced by Gram-positive bacteria or fungi, and according to Siezen et al. now is a subgroup of the subtilases. A wide variety of subtilisins have been identified, and the amino acid sequence of a number of subtilisins have been determined. These include more than six subtilisins from Bacillus strains, namely, subtilisin 168, subtilisin BPN′, subtilisin Carlsberg, subtilisin Y, subtilisin amylosacchariticus, and mesentericopeptidase (Kurihara et al. (1972) J. Biol. Chem. 247 5629-5631; Wells et al. (1983) Nucleic Acids Res. 11 7911-7925; Stahl and Ferrari (1984) J. Bacteriol. 159 811-819, Jacobs et al. (1985) Nucl. Acids Res. 13 8913-8926; Nedkov et al. (1985) Biol. Chem. Hoppe-Seyler 366 421-430, Svendsen et al. (1986) FEBS Lett. 196 228-232), one subtilisin from an actinomycetales, thermitase from Thermoactinomyces vulgaris (Meloun et al. (1985) FEBS Lett. 198 195-200), and one fungal subtilisin, proteinase K from Tritirachium album (Jany and Mayer (1985) Biol. Chem. Hoppe-Seyler 366 584-492). for further reference Table I from Siezen et al. has been reproduced below.

Subtilisins are well-characterized physically and chemically. In addition to knowledge of the primary structure (amino acid sequence) of these enzymes, over 50 high resolution X-ray structures of subtilisins have been determined which delineate the binding of substrate, transition state, products, at least three different protease inhibitors, and define the structural consequences for natural variation (Kraut (1977) Ann. Rev. Biochem. 46 331-358).

One subgroup of the subtilases, I-S1, comprises the “classical” subtilisins, such as subtilisin 168, subtilisin BPN′, subtilisin Carlsberg (ALCALASE®, Novozymes A/S), and subtilisin DY.

A further subgroup of the subtilases I-S2, is recognised by Siezen et al. (supra). Sub-group I-S2 proteases are described as highly alkaline subtilisins and comprise enzymes such as subtilisin PB92 (MAXACAL®), Gist-Brocades NV), subtilisin 309 (SAVINASE®, Novozymes A/S), subtilisin 147 (ESPERASE®, Novozymes A/S), and alkaline elastase YaB.

Random and site-directed mutations of the subtilase gene have both arisen from knowledge of the physical and chemical properties of the enzyme and contributed information relating to subtilase's catalytic activity, substrate specificity, tertiary structure, etc. (Wells et al. (1987) Proc. Natl. Acad. Sci. U.S.A. 84; 1219-1223; Wells et al. (1986) Phil. Trans. R. Soc. Lond. A. 317 415-423; Hwang and Warshel (1987) Biochem. 26 2669-2673; Rao et al., (1987) Nature 328 551-554.

More recent publications covering this area are Carter et al. (1989) Proteins 6 240-248 relating to design of variants that cleave a specific target sequence in a substrate (positions 24 and 64); Graycar et al. (1992) Annals of the New York Academy of Sciences 672 71-79 discussing a number of previously published results; and Takagi (1993) Int. J. Biochem. 25 307-312 also reviewing previous results.

Examples of commercially available proteases (peptidases) include Kannase™, Everlase™, Esperase™, Alcalase™, Neutrase™, Durazym™, Savinase™, Ovozyme™, Pyrase™, Pancreatic Trypsin NOVO (PTN), Bio-Feed™ Pro and Clear-Lens™ Pro (all available from Novozymes A/S, Bagsvaerd, Denmark). Other preferred proteases include those described in WO 01/58275 and WO 01/58276.

Other commercially available proteases include Ronozyme™ Pro, Maxatase™, Maxacal™, Maxapem™, Opticlean™, Propease™, Purafect™ and Purafect Ox™ (available from Genencor International Inc., Gist-Brocades, BASF, or DSM Nutritional Products).

Lipases: Suitable lipases include those of bacterial or fungal origin. Chemically or genetically modified mutants are included.

Examples of useful lipases include a Humicola lanugi-nosa lipase, e.g., as described in EP 258 068 and EP 305 216, a Rhizomucor miehei lipase, e.g., as described in EP 238 023, a Candida lipase, such as a C. antarctica lipase, e.g., the C. antarctica lipase A or B described in EP 214 761, a Pseudomonas lipase such as a P. pseudoalcaligenes and P. alcaligenes lipase, e.g., as described in EP 218 272, a P. cepacia lipase, e.g., as described in EP 331 376, a P. stutzeri lipase, e.g., as disclosed in BP 1,372,034, a P. fluorescens lipase, a Bacillus lipase, e.g., a B. subtilis lipase (Dar-tois et al., (1993), Biochemica et Biophysica acta 1131, 253-260), a B. stearothermophilus lipase (JP 64/744992) and a B. pumilus lipase (WO 91/16422).

Furthermore, a number of cloned lipases may be useful, including the Penicillium camenbertii lipase described by Ya-maguchi et al., (1991), Gene 103, 61-67), the Geotricum can-didum lipase (Schimada, Y. et al., (1989), J. Biochem. 106, 383-388), and various Rhizopus lipases such as a R. delemar lipase (Hass, M. J et al., (1991), Gene 109, 117-113), a R. niveus lipase (Kugimiya et al., (1992), Biosci. Biotech. Biochem. 56, 716-719) and a R. oryzae lipase.

Other types of lipolytic enzymes such as cutinases may also be useful, e.g., a cutinase derived from Pseudomonas mendocina as described in WO 88/09367, or a cutinase derived from Fusarium solani pisi (e.g. described in WO 90/09446).

Examples of commercially available lipases include LipeX™, Lipoprime™, Lipopan™, Lipolase™, Lipolase™Ultra, Lipozyme™, Palatase™, Resinase™, Novozym™ 435 and Lecitase™(all available from Novozymes A/S).

Other commercially available lipases include Lumafast™ (Pseudomonas mendocina lipase from Genencor International Inc.); Lipomax™ (Ps. pseudoalcaligenes lipase from Gist-Brocades/Genencor Int. Inc.; and Bacillus sp. lipase from Solvay enzymes. Further lipases are available from other suppliers such as Lipase P “Amano” (Amano Pharmaceutical Co. Ltd.).

Amylases: Suitable amylases (α and/or β) include those of bacterial or fungal origin. Chemically or genetically modified mutants are included. Amylases include, for example, a-amylases obtained from a special strain of B. licheniformis, described in more detail in British Patent Specification No. 1,296,839. Commercially available amylases are Duramyl™, Termamyl™, Fungamyl™ and BAN™ (available from Novozymes A/S) and Rapidase™ and Maxamyl P™ (available from Gist-Brocades).

Cellulases: Suitable cellulases include those of bacterial or fungal origin. Chemically or genetically modified mutants are included. Suitable cellulases are disclosed in U.S. Pat. No. 4,435,307, which discloses fungal cellulases produced from Humicola insolens. Especially suitable cellulases are the cellulases having color care benefits. Examples of such cellulases are cellulases described in European patent application No. 0 495 257.

Oxidoreductases: Any oxidoreductase suitable for use in a liquid composition, e.g., peroxidases or oxidases such as laccases, can be used herein. Suitable peroxidases herein include those of plant, bacterial or fungal origin. Chemically or genetically modified mutants are included. Examples of suitable peroxidases are those derived from a strain of Coprinus, e.g., C. cinerius or C. macrorhizus, or from a strain of Bacillus, e.g., B. pumilus, particularly peroxidase according to WO 91/05858. Suitable laccases herein include those of bacterial or fungal origin. Chemically or genetically modified mutants are included. Examples of suitable laccases are those obtainable from a strain of Trametes, e.g., T. villosa or T. versicolor, or from a strain of Coprinus, e.g., C. cinereus, or from a strain of Myceliophthora, e.g., M. thermophila.

The types of enzymes which may be present in the liquid of the invention include oxidoreductases (EC 1.-.-.-), transferases (EC 2.-.-.-), hydrolases (EC 3.-.-.-), lyases (EC 4.-.-.-), isomerases (EC 5.-.-.-) and ligases (EC 6.-.-.-).

Preferred oxidoreductases in the context of the invention are peroxidases (EC 1.11.1), laccases (EC 1.10.3.2) and glucose oxidases (EC 1.1.3.4)]. An Example of a commercially available oxidoreductase (EC .1-.-.-) is Gluzyme™ (enzyme available from Novozymes A/S). Further oxidoreductases are available from other suppliers. Preferred transferases are transferases in any of the following sub-classes:
a Transferases transferring one-carbon groups (EC 2.1);
b transferases transferring aldehyde or ketone residues (EC 2.2); acyltransferases (EC 2.3);
c glycosyltransferases (EC 2.4);
d transferases transferring alkyl or aryl groups, other that methyl groups (EC 2.5); and
e transferases transferring nitrogeneous groups (EC 2.6).

A most preferred type of transferase in the context of the invention is a transglutaminase (protein-glutamine γ-glutamyltransferase; EC 2.3.2.13).

Further examples of suitable transglutaminases are described in WO 96/06931 (Novo Nordisk A/S).

Preferred hydrolases in the context of the invention are: carboxylic ester hydrolases (EC 3.1.1.-) such as lipases (EC 3.1.1.3); phytases (EC 3.1.3.-), e.g. 3-phytases (EC 3.1.3.8) and 6-phytases (EC 3.1.3.26); glycosidases (EC 3.2, which fall within a group denoted herein as “carbohydrases”), such as α-amylases (EC 3.2.1.1); peptidases (EC 3.4, also known as proteases); and other carbonyl hydrolases. Examples of commercially available phytases include Bio-Feed™ Phytase (Novozymes), Ronozyme™ (DSM Nutritional Products), Natuphos™ (BASF), Finase™ (AB Enzymes), and the Phyzyme™ product series (Danisco). Other preferred phytases include those described in WO 98/28408, WO 00/43503, and WO 03/066847.

In the present context, the term “carbohydrase” is used to denote not only enzymes capable of breaking down carbohydrate chains (e.g. starches or cellulose) of especially five- and six-membered ring structures (i.e. glycosidases, EC 3.2), but also enzymes capable of isomerizing carbohydrates, e.g. six-membered ring structures such as D-glucose to five-membered ring structures such as D-fructose.

Carbohydrases of relevance include the following (EC numbers in parentheses): α-amylases (EC 3.2.1.1), β-amylases (EC 3.2.1.2), glucan 1,4-α-glucosidases (EC 3.2.1.3), endo-1,4-beta-glucanase (cellulases, EC 3.2.1.4), endo-1,3(4)-β-glucanases (EC 3.2.1.6), endo-1,4-β,-xylanases (EC 3.2.1.8), dextranases (EC 3.2.1.11), chitinases (EC 3.2.1.14), polygalacturonases (EC 3.2.1.15), lysozymes (EC 3.2.1.17), β-glucosidases (EC 3.2.1.21), α-galactosidases (EC 3.2.1.22), β-galactosidases (EC 3.2.1.23), amylo-1,6-glucosidases (EC 3.2.1.33), xylan 1,4-β-xylosidases (EC 3.2.1.37), glucan endo-1,3-β-D-glucosidases (EC 3.2.1.39), α-dextrin endo-1,6-α-glucosidases (EC3.2. 1.41), sucrose α-glucosidases (EC 3.2.1.48), glucan endo-1,3-α-glucosidases (EC 3.2.1.59), glucan 1,4-β-glucosidases (EC 3.2.1.74), glucan endo-1,6-β-glucosidases (EC 3.2.1.75), galactanases (EC 3.2.1.89), arabinan endo-1,5-α-L-arabinosidases (EC 3.2.1.99), lactases (EC 3.2.1.108), chitosanases (EC 3.2.1.132) and xylose isomerases (EC 5.3.1.5).

Examples of commercially available carbohydrases include Alpha-Gal™, Bio-Feed™ Alpha, Bio-Feed™ Beta, Bio-Feed™ Plus, Bio-Feed™ Wheat, Bio-Feed™ Z, Novozyme™ 188, Carezyme™, Celluclast™, Cellusoft™, Celluzyme™, Ceremyl™, Citrozym™, Denimax™, Dezyme™, Dextrozyme™, Duramyl™, Energex™, Finizym™, Fungamyl™, Gamanase™, Glucanex™, Lactozym™, Liquezyme™, Maltogenase™, Natalase™, Pentopan™, Pectinex™, Promozyme™, Pulpzyme™, Novamyl™, Termamyl™, AMG™ (Amyloglucosidase Novo), Maltogenase™, Sweetzyme™ and Aquazym™ (all available from Novozymes A/S). Further carbohydrases are available from other suppliers, such as the Roxazyme™ and Ronozyme™ product series (DSM Nutritional Products), the Avizyme™, Porzyme™ and Grindazyme™ product series (Danisco, Finnfeeds), and Natugrain™ (BASF), Purastar™ and Purastar™ OxAm (Genencor).

Other commercially available enzymes include Mannaway™, Pectaway™, Stainzyme™ and Renozyme™.

Surfactant

Suitable surfactants to avoid precipitation in the liquid enzyme additive may be any surfactant. The surfactant of the present invention may be anionic, nonionic, cationic, or amphoteric (zwitterionic).

It has been found that particularly surfactants with a HLB value above 8 are suitable. In a particular embodiment of the present invention the HLB value of the surfactant is at least 9 such as at least 10. In a more particular embodiment the HLB value is between 10 and 20. In a more particular embodiment the HLB value of the surfactant is between 11 and 15.

In a particular embodiment of the present invention the surfactant is soluble in the enzyme liquid additive in the temperature range of 0 to 40° C. and do not phase separate. In a more particular embodiment the surfactant can be added as a mixture of two or more surfactants.

The amount of surfactant added is in particular 0.1 to 10% w/w of the total liquid additive more particular 0.25 to 8% w/w such as even more particular 0.5 to 5% w/w.

In a particular embodiment of the present invention the amount of surfactant is less than 1% w/w of the total liquid enzyme additive. In a particular embodiment of the present invention the amount of surfactant is less than 0.7% w/w of the total liquid enzyme additive.

In a particular embodiment of the present invention the amount of surfactant added to the enzyme liquid additive is at least 0.1% w/w. In a more particular embodiment of the present invention the surfactant is added to the liquid enzyme additive is at least 0.25% w/w. In an even more particular embodiment the surfactant is added to the liquid enzyme additive is at least 0.5% w/w. In a most particular embodiment of the present invention the surfactant is added to the liquid enzyme additive is at least 1% w/w.

In a particular embodiment of the present invention the amount of surfactant added to the enzyme liquid additive is less than 20% w/w. In a more particular embodiment of the present invention the amount of surfactant added to the enzyme liquid additive is less than 15% w/w. In an even more particular embodiment of the present invention the amount of surfactant added to the enzyme liquid additive is less than 10% w/w. In a most particular embodiment of the present invention the amount of surfactant added to the enzyme liquid additive is less than 5%.

In a particular embodiment of the present invention the surfactant is a non-ionic surfactant. The nonionic surfactants are alcohol ethoxylate (AEO or AE), alcohol propoxylate, carboxylated alcohol ethoxylates, nonylphenol ethoxylate, alkylpolyglycoside, alkyldimethylamine oxide, ethoxylated fafty acid monoethanolamide, fatty acid monoethanolamide, or polyhydroxy alkyl fatty acid amide (e.g. as described in WO 92/06154).

Polyethylene, polypropylene, and polybutylene oxide condensates of alkyl phenols. These compounds include the condensation products of alkyl phenols having an alkyl group containing from about 6 to about 14 carbon atoms, preferably from about 8 to about 14 carbon atoms, in either a straight chain or branched-chain configuration with the alkylene oxide. In a preferred embodiment, the ethylene oxide is present in an amount equal to from about 2 to about 25 moles, more preferably from about 3 to about 15 moles, of ethylene oxide per mole of alkyl phenol. Commercially available nonionic surfactants of this type include Igepal™ CO-630, marketed by the GAF Corporation; and Triton™ X-45, X-114, X-100 and X-102, all marketed by the Rohm & Haas Company. These surfactants are commonly referred to as alkylphenol alkoxylates (e.g., alkyl phenol ethoxylates).

The condensation products of primary and secondary aliphatic alcohols with about 1 to about 25 moles of ethylene oxide are preferred as the nonionic surfactant. The alkyl chain of the aliphatic alcohol can either be straight or branched, primary or secondary, and generally contains from about 8 to about 22 carbon atoms. Preferred are the condensation products of alcohols having an alkyl group containing from about 8 to about 20 carbon atoms, more preferably from about 10 to about 18 carbon atoms, with from about 3 moles of ethylene oxide per mole of alcohol. Examples of commercially available nonionic surfactants of this type include Tergitol™ 15-S-9 (The condensation product of C₁₁-C₁₅ linear alcohol with 9 moles ethylene oxide), Tergitol™ 24-L-6 NMW (the condensation product of C₁₂-C₁₄ primary alcohol with 6 moles ethylene oxide with a narrow molecular weight distribution), both marketed by Union Carbide Corporation; Neodol™ 45-9 (the condensation product of C₁₄-C₁₅ linear alcohol with 9 moles of ethylene oxide), Neodol™ 23-3 (the condensation product of C₁₂-C₁₃ linear alcohol with 3.0 moles of ethylene oxide), Neodol™ 45-7 (the condensation product of C₁₄-C₁₅ linear alcohol with 7 moles of ethylene oxide), Neodol™ 45-5 (the condensation product of C₁₄-C₁₅ linear alcohol with 5 moles of ethylene oxide) marketed by Shell Chemical Company, Kyro™ EOB (the condensation product of C₁₃-C₁₅ alcohol with 9 moles ethylene oxide), marketed by The Procter & Gamble Company, and Genapol LA 050 (the condensation product of C₁₂-C₁₄ alcohol with 5 moles of ethylene oxide) marketed by Hoechst. Lutensol® AN, AT, AO and TO types marketed by BASF. Preferred range of HLB in these products is from 8-20 and most preferred from 8-18.

Especially surfactants with the following formula are preferred:

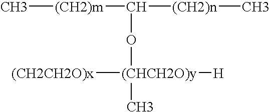

With n+m=9-11, x indicating the average number of ethylene oxide groups and y indicating the average number of propyleneoxide groups. Examples of commercially available nonionic surfactants of this type include Softanol® from Ineos Oxide, Belgium.

Also useful as the nonionic surfactant of the present invention are alkylpolysaccharides disclosed in U.S. Pat. No. 4,565,647, having a hydrophobic group containing from about 6 to about 30 carbon atoms, preferably from about 10 to about 16 carbon atoms and a polysaccharide, e.g. a polyglycoside, hydrophilic group containing from about 1.3 to about 10, preferably from about 1.3 to about 3, most preferably from about 1.3 to about 2.7 saccharide units. Any reducing saccharide containing 5 or 6 carbon atoms can be used, e.g., glucose, galactose and galactosyl moieties can be substituted for the glucosyl moieties (optionally the hydrophobic group is attached at the 2-, 3-, 4-, etc. positions thus giving a glucose or galactose as opposed to a glucoside or galactoside). The intersaccharide bonds can be, e.g., between the one position of the additional saccharide units and the 2-, 3-, 4-, and/or 6- positions on the preceding saccharide units.

The preferred alkylpolyglycosides have the formula:
R²O(CₙH₂ₙO)ₜ(glycosyl)ₓ
wherein R² is selected from the group consisting of alkyl, alkylphenyl, hydroxyalkyl, hydroxyalkylphenyl, and mixtures thereof in which the alkyl groups contain from about 10 to about 18, preferably from about 12 to about 14, carbon atoms; n is 2 or 3, preferably 2; t is from 0 to about 10, preferably 0; and x is from about 1.3 to about 10, preferably from about 1.3 to about 3, most preferably from about 1.3 to about 2.7. The glycosyl is preferably derived from glucose. To prepare these compounds, the alcohol or alkylpolyethoxy alcohol is formed first and then reacted with glucose, or a source of glucose, to form the glucoside (attachment at the 1-position). The additional glycosyl units can then be attached between their 1-position and the preceding glycosyl units 2-, 3-, 4-, and/or 6-position, preferably predominantly the 2-position. The condensation products of ethylene oxide with a hydrophobic base formed by the condensation of propylene oxide with propylene glycol are also suitable as surfactant. The hydrophobic portion of these compounds will preferably have a molecular weight from about 1500 to about 1800 and will exhibit water insolubility. The addition of polyoxyethylene moieties to this hydrophobic portion tends to increase the water solubility of the molecule as a whole, and the liquid character of the product is retained up to the point where the polyoxyethylene content is about 50% of the total weight of the condensation product, which corresponds to condensation with up to about 40 moles of ethylene oxide. Examples of compounds of this type include certain of the commercially available Pluronic™ surfactants, marketed by BASF.

Also suitable for use as the nonionic surfactant of the nonionic surfactant system of the present invention, are the condensation products of ethylene oxide with the product resulting from the reaction of propylene oxide and ethylenediamine. The hydrophobic moiety of these products consists of the reaction product of ethylenediamine and excess propylene oxide, and generally has a molecular weight of from about 2500 to about 3000. This hydrophobic moiety is condensed with ethylene oxide to the extent that the condensation product contains from about 40% to about 80% by weight of polyoxyethylene and has a molecular weight of from about 5,000 to about 11,000. Examples of this type of nonionic surfactant include certain of the commercially available Tetronic™ compounds, marketed by BASF.

Other suitable surfactants may be polyethylene oxide condensates of alkyl phenols, condensation products of primary and secondary aliphatic alcohols with from about 1 to about 25 moles of ethyleneoxide, alkylpolysaccharides, and mixtures hereof. Most preferred are C₈-C₁₄ alkyl phenol ethoxylates having from 3 to 15 ethoxy groups.

Other suitable nonionic surfactants may be polyhydroxy fatty acid amide surfactants of the formula 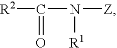
wherein R¹ is H, or R¹ is C₁₋₄ hydrocarbyl, 2-hydroxyethyl, 2-hydroxypropyl or a mixture thereof, R² is C₅₋₃₁ hydrocarbyl, and Z is a polyhydroxyhydrocarbyl having a linear hydrocarbyl chain with at least 3 hydroxyls directly connected to the chain, or an alkoxylated derivative thereof. Preferably, R¹ is methyl, R² is straight C₁₁₋₁₅ alkyl or C₁₆₋₁₈ alkyl or alkenyl chain such as coconut alkyl or mixtures thereof, and Z is derived from a reducing sugar such as glucose, fructose, maltose or lactose, in a reductive amination reaction.

In a particular embodiment of the present invention the surfactants are selected from the group consisting of:
R—O—(CH₂CH₂O)ₙH

Wherein R is a branched or linear alkane with 8 to 22 carbon atoms and n is equal to or higher than 3. In a preferred embodiment n is equal to or higher than 4, in a more preferred embodiment n is equal to or higher than 5. n may be but is not limited to 3, 7, 8, 15 and 80.

In a particular embodiment the average chain length is C12 to C18, in a more preferred embodiment the average chain length is C13 to C16, in a more particular embodiment the average chain length is C13 to C 15,

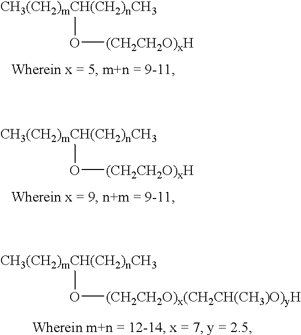

In another particular embodiment of the present invention the surfactant is chosen from the group covered by:
CAS. No. 68131-40-8 which covers a group of compounds with following synonyms C11-15-sec-alkyl-omega-hydroxypoly(oxy-1,2-ethanediyl); C11-15-secondary alcohols, ethoxylated; Ethoxylated Secondary Alcohols; SM-9; Tergitol 15-S-9 and CAS. No. 69227-20-9 Which covers ethoxylated alcohol-(C16-C22),

In a particular embodiment the surfactant is selected from the group consisting of:

The surfactant may also be ethoxylates of amines, amides and acids. Furthermore, the surfactants may be a co-polymer of ethoxylate and propoxylate, including but not limited to ethoxypropoxy block co-polymers of alcohol, amines, amides and acids.

Suitable anionic surfactants include alkyl alkoxylated sulfate surfactants. Examples hereof are water soluble salts or acids of the formula RO(A)ₘSO3M wherein R is an unsubstituted C₁₀-C-₂₄ alkyl or hydroxyalkyl group having a C₁₀-C₂₄ alkyl component, preferably a C₁₂-C₂₀ alkyl or hydro-xyalkyl, more preferably C₁₂-C₁₈ alkyl or hydroxyalkyl, A is an ethoxy or propoxy unit, m is greater than zero, typically between about 0.5 and about 6, more preferably between about 0.5 and about 3, and M is H or a cation which can be, for example, a metal cation (e.g., sodium, potassium, lithium, calcium, magnesium, etc.), ammonium or substituted-ammonium cation. Alkyl ethoxylated sulfates as well as alkyl propoxylated sulfates are contemplated herein. Specific examples of substituted ammonium cations include methyl-, dimethyl, trimethyl-ammonium cations and quaternary ammonium cations such as tetramethyl-ammonium and dimethyl piperdinium cations and those derived from alkylamines such as ethylamine, diethylamine, triethylamine, mixtures thereof, and the like. Exemplary surfactants are C₁₂-C₁₈ alkyl polyethoxylate (1.0) sulfate (C₁₂-C₁₈E(1.0)M), C₁₂-C₁₈ alkyl polyethoxylate (2.25) sulfate (C₁₂-C₁₈(2.25)M, and C₁₂-C₁₈ alkyl polyethoxylate (3.0) sulfate (C₁₂-C₁₈E(3.0) and C₁₂-C₁₈ alkyl polyethoxylate (4.0) sulfate (C₁₂-C₁₈E(4.0)M), wherein M is conveniently selected from sodium and potassium.

Other suitable anionic surfactants to be used may be alkylbenzenesulfonate (LAS), alphaolefinsulfonate (AOS), alkyl sulfate (fatty alcohol sulfate) (AS), alcohol ethoxysulfate (AEOS or AES), secondary alkanesulfonates (SAS), alpha-sulfo fatty acid methyl esters, alkyl- or alkenylsuccinic acid, xylene sulfonate or soap, alkyl ester sulfonate surfactants including linear esters of C₈-C₂₀ carboxylic acids (i.e., fatty acids) which are sulfonated with gaseous SO₃ according to “The Journal of the American Oil Chemists Society”, 52 (1975), pp. 323-329. Suitable starting materials would include natural fatty substances as derived from tallow, palm oil, etc. A preferred anionic surfactant is a sodium, potassium or ammonium salt of xylenesulfonic acid such as (CH3)2C6H3SO3Na.

Suitable alkyl ester sulfonate surfactant, comprise alkyl ester sulfonate surfactants of the structural formula: 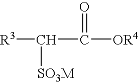
wherein R³ is a C₈-C₂₀ hydrocarbyl, preferably an alkyl, or combination thereof, R⁴ is a C₁-C₆ hydrocarbyl, preferably an alkyl, or combination thereof, and M is a cation which forms a water soluble salt with the alkyl ester sulfonate. Suitable salt-forming cations include metals such as sodium, potassium, and lithium, and substituted or unsubstituted ammonium cations, such as monoethanolamine, diethonolamine, and triethanolamine. Preferably, R³ is C₁₀-C₁₆ alkyl, and R⁴ is methyl, ethyl or isopropyl. Especially preferred are the methyl ester sulfonates wherein R³ is C₁₀-C₁₆ alkyl.

Other suitable anionic surfactants include the alkyl sulfate surfactants which are water soluble salts or acids of the formula ROSO₃M wherein R preferably is a C₁₀-C₂₄ hydrocarbyl, preferably an alkyl or hydroxyalkyl having a C₁₀-C₂₀ alkyl component, more preferably a C₁₂-C₁₈ alkyl or hydroxyalkyl, and M is H or a cation, e.g., an alkali metal cation (e.g. sodium, potassium, lithium), or ammonium or substituted ammonium (e.g. methyl-, dimethyl-, and trimethyl ammonium cations and quaternary ammonium cations such as tetramethyl-ammonium and dimethyl piperdinium cations and quaternary ammonium cations derived from alkylamines such as ethylamine, diethylamine, triethylamine, and mixtures thereof, and the like). Typically, alkyl chains of C₁₂-C₁₆ are preferred for lower wash temperatures (e.g. below about 50° C.) and C₁₆-C₁₈ alkyl chains are preferred for higher wash temperatures (e.g. above about 50° C.).

Other anionic surfactants may include salts (including, for example, sodium, potassium, ammonium, and substituted ammonium salts such as mono- di- and triethanolamine salts) of soap, C₈-C₂₂ primary or secondary alkanesulfonates, C₈-C₂₄ olefinsulfonates, sulfonated polycarboxylic acids prepared by sulfonation of the pyrolyzed product of alkaline earth metal citrates, e.g., as described in British patent specification No. 1,082,179, C₈-C₂₄ alkylpolyglycolethersulfates (containing up to 10 moles of ethylene oxide); alkyl glycerol sulfonates, fatty acyl glycerol sulfonates, fatty oleyl glycerol sulfates, alkyl phenol ethylene oxide ether sulfates, paraffin sulfonates, alkyl phosphates, isethionates such as the acyl isethionates, N-acyl taurates, alkyl succinamates and sulfosuccinates, monoesters of sulfosuccinates (especially saturated and unsaturated C₁₂-C₁₈ monoesters) and diesters of sulfosuccinates (especially saturated and unsaturated C₆-C₁₂ diesters), acyl sarcosinates, sulfates of alkylpolysaccharides such as the sulfates of alkylpolyglucoside (the nonionic nonsulfated compounds being described below), branched primary alkyl sulfates, and alkyl polyethoxy carboxylates such as those of the formula RO(CH₂CH₂O)ₖ—CH₂COO—M+ wherein R is a C₈-C₂₂ alkyl, k is an integer from 1 to 10, and M is a soluble salt forming cation. Resin acids and hydrogenated resin acids are also suitable, such as rosin, hydrogenated rosin, and resin acids and hydrogenated resin acids present in or derived from tall oil.

Alkylbenzene sulfonates may be suitable. Especially linear straight-chain) alkyl benzene sulfonates (LAS) wherein the alkyl group preferably contains from 10 to 18 carbon atoms.

Further examples are described in “Surface Active Agents and Detergents” (Vol. I and II by Schwartz, Perrry and Berch). A variety of such surfactants are also generally disclosed in U.S. Pat. No. 3,929,678, (Column 23, line 58 through Column 29, line 23, herein incorporated by reference).

Cationic surfactants suitable are those having one long-chain hydrocarbyl group. Examples of such cationic surfactants include the ammonium surfactants such as alkyltrimethylammonium halogenides, and those surfactants having the formula:
[R²(OR³)_{y}][R⁴(OR³)_{y}]₂R⁵N+X—
wherein R² is an alkyl or alkyl benzyl group having from about 8 to about 18 carbon atoms in the alkyl chain, each R³ is selected form the group consisting of —CH₂CH₂—, —CH₂CH(CH₃)—, —CH₂CH(CH₂OH)—, —CH₂CH₂CH₂—, and mixtures thereof; each R⁴ is selected from the group consisting of C₁-C₄ alkyl, C₁-C₄ hydroxyalkyl, benzyl ring structures formed by joining the two R⁴ groups, —CH₂CHOHCHOHCOR⁶CHOHCH₂OH, wherein R⁶ is any hexose or hexose polymer having a molecular weight less than about 1000, and hydrogen when y is not 0; R⁵ is the same as R⁴ or is an alkyl chain,wherein the total number of carbon atoms or R² plus R⁵ is not more than about 18; each y is from 0 to about 10, and the sum of the y values is from 0 to about 15; and X is any compatible anion.

Suitable cationic surfactants may be the water soluble quaternary ammonium compounds useful in the present composition having the formula:
R₁R₂R₃R₄N⁺X⁻ (i)
wherein R₁ is C₈-C₁₆ alkyl, each of R₂, R₃ and R₄ is independently C₁-C₄ alkyl, C₁-C₄ hydroxy alkyl, benzyl, and —(C₂H₄₀)ₓH where x has a value from 2 to 5, and X is an anion. Not more than one of R₂, R₃ or R₄ should be benzyl.

The preferred alkyl chain length for R₁ is C₁₂-C₁₅, particularly where the alkyl group is a mixture of chain lengths derived from coconut or palm kernel fat or is derived synthetically by olefin build up or OXO alcohols synthesis.

Preferred groups for R₂R₃ and R₄ are methyl and hydroxyethyl groups and the anion X may be selected from halide, methosulphate, acetate and phosphate ions.

Examples of suitable quaternary ammonium compounds of formulae (i) for use herein are:
coconut trimethyl ammonium chloride or bromide;
coconut methyl dihydroxyethyl ammonium chloride or bromide;
decyl triethyl ammonium chloride;
decyl dimethyl hydroxyethyl ammonium chloride or bromide;
C_{12-C15} dimethyl hydroxyethyl ammonium chloride or bromide;
coconut dimethyl hydroxyethyl ammonium chloride or bromide;
myristyl trimethyl ammonium methyl sulphate;
lauryl dimethyl benzyl ammonium chloride or bromide;
lauryl dimethyl (ethenoxy)₄ ammonium chloride or bromide;
choline esters (compounds of formula (i) wherein R₁ is 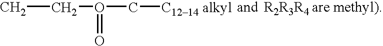
   di-alkyl imidazolines [compounds of formula (i)].

Other cationic surfactants useful herein are also described in U.S. Pat. No. 4,228,044 and in EP 000 224. Ampholytic surfactants may also be suitable. These surfactants can be broadly described as aliphatic derivatives of secondary or tertiary amines, or aliphatic derivatives of heterocyclic secondary and tertiary amines in which the aliphatic radical can be straight- or branched-chain. One of the aliphatic substituents contains at least about 8 carbon atoms, typically from about 8 to about 18 carbon atoms, and at least one contains an anionic water-solubilizing group, e.g. carboxy, sulfonate, sulfate. See U.S. Pat. No. 3,929,678 (column 19, lines 18-35) for examples of ampholytic surfactants.

Zwitterionic surfactants may also be suitable. These surfactants can be broadly described as derivatives of secondary and tertiary amines, derivatives of heterocyclic secondary and tertiary amines, or derivatives of quaternary ammonium, quaternary phosphonium or tertiary sulfonium compounds. See U.S. Pat. No. 3,929,678 (column 19, line 38 through column 22, line 48) for examples of zwitterionic surfactants.

Semi-polar nonionic surfactants are a special category of nonionic surfactants which include water-soluble amine oxides containing one alkyl moiety of from about 10 to about 18 carbon atoms and 2 moieties selected from the group consisting of alkyl groups and hydroxyalkyl groups containing from about 1 to about 3 carbon atoms; watersoluble phosphine oxides containing one alkyl moiety of from about 10 to about 18 carbon atoms and 2 moieties selected from the group consisting of alkyl groups and hydroxyalkyl groups containing from about 1 to about 3 carbon atoms; and water-soluble sulfoxides containing one alkyl moiety from about 10 to about 18 carbon atoms and a moiety selected from the group consisting of alkyl and hydroxyalkyl moieties of from about 1 to about 3 carbon atoms.

Semi-polar nonionic surfactants include the amine oxide surfactants having the formula: 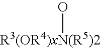
wherein R³ is an alkyl, hydroxyalkyl, or alkyl phenyl group or mixtures thereof containing from about 8 to about 22 carbon atoms; R⁴ is an alkylene or hydroxyalkylene group containing from about 2 to about 3 carbon atoms or mixtures thereof; x is from 0 to about 3: and each R⁵ is an alkyl or hydroxyalkyl group containing from about 1 to about 3 carbon atoms or a polyethylene oxide group containing from about 1 to about 3 ethylene oxide groups. The R⁵ groups can be attached to each other, e.g., through an oxygen or nitrogen atom, to form a ring structure.

These amine oxide surfactants in particular include C₁₀-C₁₈ alkyl dimethyl amine oxides and C₈-C₁₂ alkoxy ethyl dihydroxy ethyl amine oxides.

Enzyme Stabilizer:

The enzyme stabilizer of the present invention is either boronic acid and/or a derivative thereof. In a particular embodiment of the present invention the stabilizer is a phenyl boronic acid and/or a derivative thereof.

The present invention covers liquid enzyme additives comprising boronic acid or derivatives thereof. In a particular embodiment the invention covers liquid enzyme additives comprising phenyl boronic acid or derivatives thereof.

In a particular embodiment of the present invention the stabilizer is a naphthalene boronic acid derivative.

The amount of stabilizer present in the liquid enzyme additive is dependent of the amount of enzyme present in the liquid enzyme additive.

The amount of stabilizer added is in particular 0.1 to 20% (w/w) of the total liquid additive, more particular 0.5 to 8% (w/w) such as even more particular 1 to 5% (w/w).

In a particular embodiment of the present invention the amount of stabilizer is above 1% (w/w) of the total liquid additive. In a more particular embodiment of the present invention the amount of stabilizer is above 1.5% (w/w) of the total liquid additive. In a most particular embodiment of the present invention the amount of stabilizer is above 2% (w/w) of the total liquid additive.

In a particular embodiment of the present invention the amount of stabilizer added to the enzyme liquid additive is at least 0.1% (w/w). In a more particular embodiment of the present invention the stabilizer is added to the liquid enzyme additive is at least 0.5% (w/w). In an even more particular embodiment the stabilizer is added to the liquid enzyme additive is at least 1% (w/w). In a most particular embodiment of the present invention the stabilizer is added to the liquid enzyme additive is at least 1.5% (w/w).

In a particular embodiment of the present invention the amount of stabilizer added to the enzyme liquid additive is less than 20% (w/w). In a more particular embodiment of the present invention the amount of stabilizer added to the enzyme liquid additive is less than 15% (w/w). In an even more particular embodiment of the present invention the amount of stabilizer added to the enzyme liquid additive is less than 10% (w/w). In a most particular embodiment of the present invention the amount of stabilizer added to the enzyme liquid additive is less than 5% (w/w).

In a particular embodiment of the present invention the phenyl boronic acid derivative is of the following formula: 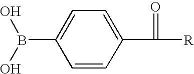
wherein R is selected from the group consisting of hydrogen, hydroxy, C₁-C₆ alkyl, substituted C₁-C₆ alkyl, C₁-C₆ alkenyl and substituted C₁-C₆ alkenyl.

A preferred embodiment of the present invention provides a liquid composition comprising an enzyme and a phenyl boronic acid derivative enzyme stabilizer of the formula disclosed above, wherein R is a C₁-C₆ alkyl, in particular wherein R is CH₃, CH₃CH₂ or CH₃CH₂CH₂, or wherein R is hydrogen. In a particular embodiment of the present invention the stabilizer of the enzyme is 4-formyl-phenyl-boronic acid (4-FPBA).

In another particular embodiment of the present invention the stabilizer is selected from the group consisting of:
thiophene-2 boronic acid, thiophene-3 boronic acid, acetamidophenyl boronic acid, benzofuran-2 boronic acid, naphtalene-1 boronic acid, naphtalene-2 boronic acid, 2-FPBA, 3-FBPA, 4-FPBA, 1-thianthrene boronic acid, 4-dibenzofuran boronic acid, 5-methylthiophene-2 boronic, acid, thionaphtrene boronic acid, furan-2 boronic acid, furan-3 boronic acid, 4,4 biphenyldiborinic acid, 6-hydroxy-2-naphtalene, 4-(methylthio) phenyl boronic acid, 4 (trimethylsilyl)phenyl boronic acid, 3-bromothiophene boronic acid, 4-methylthiophene boronic acid, 2-naphtyl boronic acid, 5-bromothiphene boronic acid, 5-chlorothiophene boronic acid, dimethylthiophene boronic acid, 2-bromophenyl boronic acid, 3-chlorophenyl boronic acid, 3-methoxy-2-thiophene, p-methyl-phenylethyl boronic acid, 2-thianthrene boronic acid, di-benzothiophene boronic acid, 4-carboxyphenyl boronic acid, 9-anthryl boronic acid, 3,5 dichlorophenyl boronic, acid, diphenyl boronic acidanhydride, o-chlorophenyl boronic acid, p-chlorophenyl boronic acid m-bromophenyl boronic acid, p-bromophenyl boronic acid, p-flourophenyl boronic acid, p-tolyl boronic acid, o-tolyl boronic acid, octyl boronic acid, 1,3,5 trimethylphenyl boronic acid, 3-chloro-4-flourophenyl boronic acid, 3-aminophenyl boronic acid, 3,5-bis-(triflouromethyl) phenyl boronic acid, 2,4 dichlorophenyl boronic acid, 4-methoxyphenyl boronic acid.

Further suitable boronic acid derivatives suitable as stabilizers are described in U.S. Pat. No. 4,963,655, U.S. Pat. No. 5,159,060, WO 95/12655, WO 95/29223, WO 92/19707, WO 94/04653, WO 94/04654, U.S. Pat. No. 5,442,100, U.S. Pat. No. 5,488,157 and U.S. Pat. No. 5,472,628.

Alkaline Compounds

Any compound providing a pH above 7 when added to the liquid enzyme additive may be used to adjust the pH of the enzyme comprising mixture. Suitable compounds may be bases e.g. sodium hydroxide, potassium hydroxide or alkaline buffer salts.

Suitable buffer salts may be potassium bicarbonate, potassium carbonate, tetra potassium pyrophosphate, potassium tripolyphosphate, sodium bicarbonate and sodium carbonate. Other suitable salts or compounds able of providing an alkaline pH may be used.

A Process for Manufacturing the Liquid Enzyme Additive

The present invention further relates to the preparation of the liquid enzyme additive.

The liquid enzyme additive comprises the enzyme, the boronic acid or derivative thereof and a surfactant. These compounds may be mixed in random order or all at the same time.

In a particular embodiment of the present invention the process of the present invention comprises the steps of:
i) providing a liquid enzyme preparation;
ii) mixing the liquid enzyme preparation of i) with a surfactant and a boronic acid or derivative thereof;

In a more particular embodiment of the present invention the process of the present invention comprises the steps of:
i) providing a liquid enzyme preparation;
ii) mixing the liquid enzyme preparation of i) with a boronic acid or derivative thereof; and
iii) adding a surfactant to the liquid enzyme additive together, before or after adding boronic acid or a derivative thereof.

In a more particular embodiment of the present invention the surfactant is mixed with the liquid enzyme preparation before boronic acid or a derivative thereof is added. In a particular embodiment of the present invention the process of manufacturing a concentrated liquid enzyme additive comprising 1.5 g/L enzyme comprises the steps of:
i) providing a liquid enzyme preparation;
ii) mixing the liquid enzyme preparation of i) with a boronic acid or derivative thereof; and
iii) adding a surfactant to the liquid enzyme additive either before or after adding boronic acid or a derivative thereof

The surfactant may be added to the fermentation broth, to a cell free fermentation broth, or to a concentrate containing the one or more enzymes before the boronic acid or a derivative thereof is added.

In a particular embodiment of the present invention the surfactant is added to a fermentation broth. In a more particular embodiment of the present invention the surfactant is added to a cell free fermentation broth. In a most preferred embodiment of the present invention the surfactant is added to an enzyme concentrate.

We have further found that the preparation method of the liquid enzyme additive in some cases may have an effect on the stability of the additive and thus on the forming of precipitates therein. In a particular embodiment of the present invention the pH of the enzyme additive is from 4.5 to 11. In a more particular embodiment of the present invention the pH of the enzyme additive is 5.5 to 10.

We have found that adjusting pH and the time of which the adjustment takes place have an effect on the forming of precipitate in the liquid enzyme additive.

We have found that the pH of the enzyme containing liquid could be adjusted to pH 7.5 to 10 to avoid precipitation, more particularly to 8 to 9.

The pH is preferably adjusted before mixing of the enzyme containing liquid and boronic acid or derivative thereof whereby the formation of precipitate is avoided. The adjustment can also take place after mixing of the enzyme and boronic acid or derivative thereof whereby the formed precipitate is dissolved.

In a particular embodiment of the present invention the process of the present invention comprises the steps of:
i) providing a liquid enzyme preparation;
ii) mixing the liquid enzyme preparation of i) with a boronic acid or derivative thereof; adjusting the pH of the liquid to 7.5 to 10 either before or after adding the boronic acid or derivative thereof.

Thus in a particular embodiment of the resent invention the process of the present invention comprises the steps of:
i) providing a liquid enzyme preparation;
ii) mixing the liquid enzyme preparation of i) with a boronic acid or derivative thereof; adjusting the pH of the liquid to 7.5 to 10 either before or after adding the boronic acid or derivative thereof and adding a surfactant to the liquid before or after adding the boronic acid or derivative thereof.

The pH may be adjusted with any suitable alkaline substance. In a particular embodiment the pH is adjusted with NaOH.

In a particular embodiment the process for manufacturing the liquid enzyme additive comprises the following steps:
i) providing a liquid enzyme preparation comprising one or more enzymes;
ii) mixing the liquid enzyme preparation of i) with a surfactant;
iii) adjusting the pH of the liquid enzyme preparation of ii) to 7.5 to 10;
iv) mixing the liquid composition of ii) with boronic acid or a derivative thereof.
   Or
i) providing a liquid enzyme preparation comprising one or more enzymes;
ii) adjusting the pH of the liquid enzyme preparation of i) to 7.5 to 10;
iii) mixing the liquid enzyme preparation of ii) with a surfactant;
iv) mixing the liquid composition of ii) with boronic acid or a derivative thereof.

In a more particular embodiment the process for manufacturing the liquid enzyme additive comprises the following steps:
i) providing a liquid enzyme preparation comprising one or more enzymes;
ii) mixing the liquid enzyme preparation of i) with a surfactant;
iii) adjusting the pH of the liquid enzyme preparation of ii) to 7.5 to 10;
iv) mixing the liquid composition of ii) with phenyl boronic acid or a derivative thereof.
   Or
i) providing a liquid enzyme preparation comprising one or more enzymes;
ii) adjusting the pH of the liquid enzyme preparation of i) to 7.5 to 10;
iii) mixing the liquid enzyme preparation of ii) with a surfactant;
iv) mixing the liquid composition of ii) with phenyl boronic acid or a derivative thereof.

The boronic acid or derivative thereof may be added to the liquid enzyme preparation as a solid or as a liquid containing the boronic acid or derivative thereof on a partly or fully dissolved form. In a particular embodiment of the present invention the boronic acid or its derivative thereof is dissolved in glycerol or 1,2-propanediol which is adjusted to pH 8.5-10 with sodium hydroxide or potasium hydroxide prior to the addition.

Compositions Comprising the Liquid Enzyme Additive of the Invention

The invention also relates to compositions comprising the liquid enzyme additive of the invention. The composition may be any composition, but particularly suitable compositions are cleaning compositions, personal care compositions, textile processing compositions e.g. bleaching, pharmaceutical compositions, leather processing compositions, pulp or paper processing compositions, food and beverage compositions and animal feed compositions.

In a particular embodiment of the present invention the liquid enzyme additive is used as a raw material in liquid detergents, e.g. laundry detergents.

The invention is further directed to the use of the liquid enzyme additive in liquid detergent composition.

According to the invention a liquid composition (e.g. Liquid detergent) comprising the liquid enzyme additive, the liquid enzyme additive may be present in a concentration of 0.01-20% w/w, preferably the composition may contain 0.05-10% w/w of the liquid enzyme additive, more preferably the liquid composition may contain 0.1-5% w/w of the liquid enzyme additive, most preferably the liquid composition may contain 0.1-3% w/w of the liquid enzyme additive.

When the liquid enzyme additive of the present invention is used in a liquid composition such as a detergent the amount of each enzyme will typically be 1-1000 mg/L, in particular 5-750 mg/L, especially 10-500 mg/L calculated as pure enzyme protein.

According to the invention a liquid composition (e.g. Liquid detergent) comprising the liquid enzyme additive, the liquid composition may contain 0.001-7.5% w/w of the boronic acid or its derivative, preferably the composition may contain 0.005-4% w/w of the boronic acid or its derivative, more preferably the composition may contain 0.005-1.2% w/w of boronic acid or its derivative, most preferably the liquid composition may contain 0.01-0.15% w/w of boronic acid or its derivative. The boronic acid or its derivative may be an acid or the alkali metal salt of said acid.

The present invention is further described by the following examples which should not be construed as limiting the scope of the invention.

### EXAMPLES

### Example 1

A protease was formulated with 4-FPBA and surfactant.

The protease was a concentrated Savinase solution containing about 40 g enzyme protein/L and 55% 1,2-propane diol, pH 5.5

Surfactants tried out in the example are seen in table 1.

TABLE 1

| | Chemical structure | HLB* |
|---|---|---|
| Surfactant A | RO—(CH₂CH₂O)ₘH | 18.7 |
| | R = C₁₈₋₂₂ alkane, m = 80 | |
| Surfactant B | 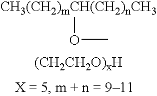 | 10.5 |
| | (CH₂CH₂O)ₓH | |
| | X = 5, m + n = 9-11 | |
| Surfactant C | 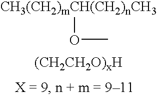 | 13.3 |
| | (CH₂CH₂O)ₓH | |
| | X = 9, n + m = 9-11 | |

*hydrophilic-lipophilic-balance

The surfactant was added to the protease (2% w/w on final composition). After mixing the pH was adjusted to 8.7 with 10 M NaOH.

The pH was measured using a pH meter PHM93 from Radiometer and a Ross® semi-micro combination pH electrode (Orion 8103SC). Before being used, the pH electrode was calibrated using standard buffers from Radiometer analytical (pH 4.005 order no.: S11M002; pH 7.000 order no.: S11M004 and pH 10.012 order no.: S11M007). The pH was measured at room temperature.

A solution of 30% 4-FPBA in 1,2-propanediol adjusted to pH 9.6 with 10 M NaOH was added to the enzyme/surfactant mixture to a final concentration of 1.6% w/w 4-FPBA.

The final enzyme concentration was 36 mg/ml

The samples were then transferred to two vials, which after sealing were incubated for 4 weeks at 5° and 40° C., respectively.

After storage, the physical stability of the samples was determined by visual inspection.

As a reference, samples were prepared following the same procedure, only without addition of the surfactant.

The result of the visual inspection see table 3.

TABLE 3

| | | physical appearance after storage* | |
|---|---|---|---|
| protease | Surfactant | 4 weeks at 5° C. | 4 weeks at 40° C. |
| Savinase | Reference | slight haze | precipitate (˜1% v/v) |
| | Surfactant A | clear | fine precipitate (<1% v/v) |
| | Surfactant B | clear | clear |
| | Surfactant C | clear | clear |

*Clear: no visible solids present; hazy: solids present suspended in liquid; precipitate: solids present precipitated at the bottom of the vial.

### Example 2

A protease was formulated with 4-FPBA and surfactant. The same three surfactants used in example 1 were tried out.

The protease was a concentrated Alcalase® solution containing 44 g enzyme/L and 30% 1,2-propane diol, pH 5.2

Surfactant was added to the protease (2% w/w on final composition).

After mixing the pH was adjusted to 8.7 with 10 M NaOH.

A solution of 30% 4-FPBA in 1,2-propanediol adjusted to pH 9.6 with 10 M NaOH was added to the enzyme/surfactant mixture to a final concentration of 1.6% w/w.

The final enzyme concentration was 40 mg/ml.

The samples were then transferred to two vials, which after sealing were incubated for 4 weeks at 5° and 40° C., respectively.

After storage, the physical stability of the samples was determined by visual inspection.

As a reference, samples were prepared following the same procedure, only without addition of the surfactant.

The result of the visual inspection see table 4.

TABLE 4

| | | physical appearance after storage* | |
|---|---|---|---|
| protease | Surfactant | 4 weeks at 5° C. | 4 weeks at 40° C. |
| Alcalase | Reference | hazy | hazy |
| | Surfactant A | clear | clear |
| | Surfactant B | hazy | hazy |
| | Surfactant C | clear | clear |

*Clear: no visible solids present; hazy: solids present suspended in liquid; precipitate: solids present precipitated at the bottom of the vial.

### Example 3

The experiment was carried out as outlined in Example 1 and 2, only the concentration of the surfactant was varied. The results are shown in table 5.

TABLE 5

| | | | physical appearance after storage* | |
|---|---|---|---|---|
| | Surfactant | | 4 weeks at | 4 weeks at |
| protease | amount of Surfactant C* | | 5° C. | 40° C. |
| Savinase | 0% | | hazy | hazy |
| | 0.5% | (w/w) | slightly hazy | slightly hazy |
| | 1% | (w/w) | slightly hazy | slightly hazy |
| | 2% | (w/w) | clear | clear |
| Alcalase | 0% | | hazy | hazy |
| | 0.5% | (w/w) | clear | two liquid phases |
| | 1% | (w/w) | clear | clear |
| | 2% | (w/w) | clear | clear |

*final concentration

It is concluded that different proteases requires different amounts of surfactant added to completely prevent precipitation.

### Example 4

A protease (same as in example 1) was formulated with 4-FPBA using the following procedure:
1) Surfactant was added to the liquid protease sample to a final concentration of 2% w/w (see table 1).
2) After mixing, the pH was adjusted to 8.7 with 10 M NaOH
3) 4-FPBA was then added to a final concentration of 1.6% w/w.
4) The samples were then transferred to two vials, which after sealing were incubated for 4 weeks at 5° and 40° C., respectively
5) After storage, the physical stability of the samples was determined by visual inspection.

As a reference, samples were prepared following steps 1-5, only without addition of the surfactant.

Ingredients:

4-FPBA solution:
30% 4-FPBA in 1,2-propanediol adjusted to pH 9.6 with 10 M NaOH
Concentrated Savinase solution containing about 40 g enzyme protein/I and 55% 1,2-propanediol, pH 5.5
30% 4-FPBA in 1,2-propanediol adjusted to pH 9.6 with 10 M NaOH
Surfactant C (from example 1)
Surfactant D: R—O—(CH₂CH₂O)ₙH, a mixture of two surfactants where R is an alkane with average chain length of 13-15 carbon atoms and n=3
Surfactant E: as surfactant D only n=7
Surfactant F: as surfactant D only R is an alkane with an average chain length of 13 carbon atoms and n=8.
Surfactant G: as surfactant F, only n=15
Surfactant H: R—O—(CH₂CH₂O)ₙH, a mixture of two surfactants where R is an alkane with average chain length of 13 carbon atoms and n=3 and 8

The results of the tests are shown in table 6.

TABLE 6

| | | | | physical appearance | |
|---|---|---|---|---|---|
| | | | | after storage* | |
| | | HLB | 4 weeks | 4 weeks | 4 weeks |
| protease | Surfactant | value** | at 5° C. | at 25° C. | at 40° C. |
| Savinase | Reference | | slight | precipitate | precipitate |
| | | | haze | (˜1% v/v) | (˜1% v/v) |
| | Surfactant C | 13.3 | clear | clear | clear |
| | | | | precipitate | |
| | | | | <1% | |
| | Surfactant D | 8 | hazy, | hazy, | hazy, |
| | | | two liquid | two liquid | two liquid |
| | | | phases | phases | phases |
| | Surfactant E | 12 | clear | clear | fine |
| | | | | | precipitate |
| | | | | | (<1% v/v) |
| | Surfactant F | 13 | clear | clear | clear |
| | Surfactant G | 15.5 | clear | clear | clear |
| | | | | precipitate | |
| | | | | <1% | |
| | Surfactant H | 12 | clear | clear | clear |

*Clear: no visible solids present; hazy: solids or oily phase present suspended in liquid; precipitate: solids present precipitated at the bottom of the vial.
**HLB value according to W. C. Griffin

The test show that surfactants with a HLB value of below 9 does not work.

Enzyme Protein Determination:

The enzyme protein concentration of an enzyme solution can be determined by a number of methods. If the specific activity of the enzyme is known, the enzyme protein concentration can be determined by first determining the enzyme activity (in units/g material) at a selected set of conditions and divide by the specific activity (in units/mg enzyme protein). The specific activity of an enzyme is determined by first purifying the enzyme to homogeneity by means known in the art. The enzyme activity is then determined in the purified sample at the same set of conditions as used for measuring the enzyme activity in the enzyme protein concentrate. The total protein concentration is also determined in the purified sample and the specific activity is then obtained by dividing the enzyme activity with the protein concentration of the purified sample. The total protein concentration can be determined by one of the many total protein assays well known in the art (A review of different colorimetric protein assays is given by Christine V. Sapan, Roger L. Lundblad and Nicholas C. Price in Biotechnol. Appl. Biochem. (1999) 29, p 99-108). If the enzyme containing solution only contains the protein of interest on active form, the enzyme protein concentration can be determined directly by measuring the total protein concentration.

The used method in the present invention is an assay based on the hydrolysis of N,N-dimethylcasein (DMC). Briefly, the protease activity is followed spectrophotometrically at 420 nm for 10 minutes after a pre-incubation period of 8 minutes. The assay is run at pH 8.3 and at 37° C. The following solutions are used for the assay:
DMC-substrate: 0.4% N,N-dimethylcasein in 90 mM sodium tetraborate, 120 mM sodium phosphate, 0.2% Brij 35, adjusted to pH 8.0.
TNBS solution: 1.73 mM 2,4,6-trinitrobenzenesulfonic acid in water.
Dilution buffer: 0.15 M KCl, 0.05 M boric acid, 0.16 M sodium sulfite, 0.2% Brij 35 adjusted to pH 9.0.
For the assay, 80 μL TNBS solution is mixed with 45 μL sample or standard (diluted in dilution buffer) and the reaction is started by the addition of 160 μL DMC-substrate.
Total protein determination:

### REFERENCE

M. Matsushita, T. Irino, T. Komoda and Y. Sakagishi “Determination of proteins by a reverse biuret method combined with the copper-bathocuproine chelate reaction”, Clinica Chimica Acta, 216 (1993), p 103-111.

1. A concentrated liquid enzyme additive comprising enzyme, boronic acid or a derivative thereof and a surfactant, wherein the enzyme is present in the amount of more than 1.5 g/L.

2. The liquid enzyme additive of claim 1, wherein the enzyme is present in an amount of more than 5 g/L.

3. The liquid enzyme additive of claim 1, wherein the pH is 5 to 10.

4. The liquid enzyme additive of claim 1, further comprising an alkaline substance such as the pH of the liquid enzyme additive is 7.5 to 10.

5. The liquid enzyme additive of claim 1, wherein the HLB value of the surfactant is at least 9.

6. The liquid enzyme additive of claim 1, wherein the HLB value of the surfactant is between 10 and 20.

7. The liquid enzyme additive of claim 1, wherein the enzyme is a protease.

8. The liquid enzyme additive of claim 7, additionally comprising a second enzyme, in particular an amylase, a lipase, a cellulase or an oxidoreductase, or any mixture thereof.

9. The liquid enzyme additive of claim 8, wherein the second enzyme is an amylase.

10. The liquid enzyme additive of claim 1, wherein the phenyl boronic acid or derivative thereof is present in the amount of up to 20% w/w of the total liquid additive.

11. The liquid enzyme additive of claims claim 1, wherein the phenyl boronic acid or phenyl boronic acid derivative is added in an amount of 0.1 to 10% w/w of the total liquid additive.

12. The liquid enzyme additive of claim 1, wherein the boronic acid or derivative thereof is a phenyl boronic acid or a derivative thereof.

13. The liquid enzyme additive of claim 12, wherein the derivative of phenyl boronic acid is a phenyl boronic acid derivative enzyme stabilizer of the following formula: 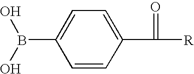
wherein R is selected from the group consisting of hydrogen, hydroxy, C₁-C₆ alkyl,
substituted C₁-C₆ alkyl, C₁-C₆ alkenyl and substituted C₁-C₆ alkenyl.

14. The liquid enzyme additive of claim 13, wherein R is C₁-C₆ alkyl.

15. The liquid enzyme additive according to claim 13, wherein R is hydrogen.

16. The liquid enzyme additive of claim 1, wherein the surfactant is selected from the group consisting of
R—O—(CH₂CH₂O)ₙH
Wherein R is a branched or linear alkane with 8 to 22 carbon atoms and n is equal to or higher than 3,

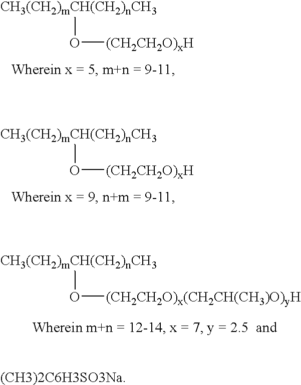

17. The liquid enzyme additive of claim 1, wherein the surfactant is added in an amount of 0.1 to 10% of the total liquid additive.

18. The liquid enzyme additive of claim 1, wherein the surfactant is added in an amount of 0.25 to 8% of the total liquid additive.

19. A process for manufacturing of the liquid enzyme additive of claim 1, comprising the steps of:
i) providing a liquid enzyme preparation;
ii) mixing the liquid enzyme preparation of i) with a surfactant and a boronic acid or derivative thereof.

20. The process of claim 19, wherein the pH of the liquid enzyme additive is 5 to 10.

21-27. (canceled)
